(19) United States
(12) Patent Application Publication
(10) Pub. No.: US 2026/0129046 A1
(43) Pub. Date: May 7, 2026

(54) DATA ACCESS

(71) Applicant: BEIJING OCEANBASE TECHNOLOGY CO., LTD., Beijing (CN)

(72) Inventors: Yi LU, Hangzhou (CN); Tianchi Liu, Hangzhou (CN)

(21) Appl. No.: 19/435,489

(22) Filed: Dec. 29, 2025

Related U.S. Application Data
(63) Continuation of application No. PCT/CN2024/125493, filed on Oct. 17, 2024.

(30) Foreign Application Priority Data
Oct. 17, 2023 (CN) 202311346789.1

(51) Int. Cl. H04L 9/40; H04L 12/46; H04L 45/74

(52) U.S. Cl. CPC H04L 63/10; H04L 12/4641; H04L 45/74

(57) ABSTRACT

This application relates to the field of communication technologies, and specifically provides a data access method and apparatus, an electronic device, and a storage medium. The data access method includes: when it is determined that a data access request sent by a client is received, obtaining an access control condition for a subnet address segment of a data server, where the subnet address segment is obtained through division from a local area network address segment corresponding to the first VPC, and the client is deployed in a second VPC; generating a data response message based on the data access request if it is determined that the data access request satisfies the access control condition; obtaining a routing table rule for the subnet address segment of the data server; and returning the data response message to the client based on the routing table rule. In this way, a quantity of consumed VPC is reduced while data isolation is ensured.

### TECHNICAL FIELD

This application relates to the field of communication technologies, and for example, to a data access method and apparatus, an electronic device, and a storage medium.

### BACKGROUND

A private network (e.g., virtual private cloud, VPC) is a cloud running on a public resource, and can ensure that resources of clients of different VPCs are isolated. Instances of different VPCs communicate through an established private connection (e.g., VPC peering).

In the related technology, a plurality of clients and a plurality of data servers are usually respectively deployed in different VPCs, and VPC peering is established between each client and a corresponding data server. During data access, the client can access the corresponding data server through an established private connection, to ensure security isolation between different data servers. In an example, the data server can be a database server, and the client can be an application (APP). When there are a relatively large quantity of data servers, a large quantity of VPCs are consumed. However, because of a limitation of a VPC resource, it is usually difficult to satisfy a VPC requirement of a user.

### SUMMARY

Embodiments of this application provide a data access method and apparatus, an electronic device, and a storage medium, which, among others, reduce a quantity of consumed VPCs while ensuring data isolation.

According to an aspect, an implementation of this application provides a data access method, applied to any data server in a data processing system. The data processing system includes at least one data server, the data processing system is deployed in a first private network VPC, and the method includes:

when it is determined that a data access request sent by a client is received, obtaining an access control condition configured for a subnet address segment of the data server, where the subnet address segment is obtained through division from a local area network address segment corresponding to the first VPC, and the client is deployed in a second VPC; generating a data response message based on the data access request if it is determined that the data access request satisfies the access control condition; obtaining a routing table rule configured for the subnet address segment of the data server; and returning the data response message to the client based on the routing table rule.

In an implementation, before the obtaining an access control condition configured for a subnet address segment of the data server, the method further includes: obtaining the local area network address segment correspondingly configured for the first VPC; dividing the local area network address segment, to obtain a plurality of subnet address segments; allocating a corresponding subnet address segment to each data server; and setting a corresponding access control condition and a corresponding routing table rule for each subnet address segment.

In an implementation, the generating a data response message based on the data access request if it is determined that the data access request satisfies the access control condition includes: obtaining a client address in the data access request; if it is determined that the client address satisfies the access control condition, performing a data query based on the data access request, to obtain a query result; and generating the data response message based on the query result and the client address.

In an implementation, the method further includes: discarding the data access request if it is determined that the client address does not satisfy the access control condition.

In an implementation, the returning the data response message to the client based on the routing table rule includes: determining a routing address segment corresponding to the client address based on the routing table rule; and sending the data response message to the client based on the routing address segment.

In an implementation, the method further includes: discarding the data response message if it is determined, based on the routing table rule, that a routing address segment corresponding to the client address does not exist.

According to an aspect, an implementation of this application provides a data access apparatus, applied to any data server in a data processing system. The data processing system includes at least one data server, the data processing system is deployed in a first private network VPC, and the apparatus includes: a receiving unit, configured to: when it is determined that a data access request sent by a client is received, obtain an access control condition configured for a subnet address segment of the data server, where the subnet address segment is obtained through division from a local area network address segment corresponding to the first VPC, and the client is deployed in a second VPC; a generation unit, configured to generate a data response message based on the data access request if it is determined that the data access request satisfies the access control condition; an obtaining unit, configured to obtain a routing table rule configured for the subnet address segment of the data server; and a returning unit, configured to return the data response message to the client based on the routing table rule.

In an implementation, the receiving unit is further configured to: obtain the local area network address segment correspondingly configured for the first VPC; divide the local area network address segment, to obtain a plurality of subnet address segments; allocate a corresponding subnet address segment to each data server; and set a corresponding access control condition and a corresponding routing table rule for each subnet address segment.

In an implementation, the generation unit is configured to: obtain a client address in the data access request; if it is determined that the client address satisfies the access control condition, perform a data query based on the data access request, to obtain a query result; and generate the data response message based on the query result and the client address.

In an implementation, the generation unit is further configured to discard the data access request if it is determined that the client address does not satisfy the access control condition.

In an implementation, the returning unit is configured to: determine a routing address segment corresponding to the client address based on the routing table rule; and send the data response message to the client based on the routing address segment.

In an implementation, the returning unit is further configured to: discard the data response message if it is determined, based on the routing table rule, that a routing address segment corresponding to the client address does not exist.

According to an aspect, an implementation of this application provides an electronic device, including: a processor; and a memory, storing computer instructions, where the computer instructions are used to enable the processor to perform the steps of the method provided in any one of the above-mentioned optional implementations of data access.

In an aspect, an implementation of this application provides a storage medium, storing computer instructions. The computer instructions are used to enable a computer to perform the steps of the method provided in any one of the above-mentioned optional implementations of data access.

In the data access method and apparatus, the electronic device, and the storage medium that are provided in the embodiments of this application, when it is determined that a data access request sent by a client is received, an access control condition configured for a subnet address segment of a data server is obtained. The subnet address segment is obtained through division from a local area network address segment corresponding to the first VPC, and the client is deployed in a second VPC. A data response message is generated based on the data access request if it is determined that the data access request satisfies the access control condition. A routing table rule configured for the subnet address segment of the data server is obtained. The data response message is returned to the client based on the routing table rule. In this way, the local area network address segment corresponding to the first VPC is divided into a plurality of subnet address segments, and different access control conditions and routing table rules are respectively set for different subnet address segments, so that the data server can limit access traffic based on an access control condition and a routing table rule of a corresponding subnet address segment, and a VPC does not need to be applied for each data server. In this way, a quantity of consumed VPCs is reduced while data isolation is ensured.

### BRIEF DESCRIPTION OF DRAWINGS

To describe the technical solutions in example implementations of this application more clearly, the following briefly describes the accompanying drawings used for describing the example implementations. Apparently, the accompanying drawings in the following descriptions show some implementations of this application, and a person of ordinary skill in the art may still derive other accompanying drawings from these accompanying drawings without creative efforts.

FIG. 1 is an example diagram of an architecture of a data access system in a related technology;

FIG. 2 is an example diagram of an architecture of a data access system according to an embodiment of this application;

FIG. 3 is a flowchart of a data access method according to an embodiment of this application;

FIG. 4 is a structural block diagram of a data access apparatus according to an embodiment of this application; and

FIG. 5 is a schematic structural diagram of an electronic device according to an embodiment of this application.

### DESCRIPTION OF EMBODIMENTS

The following clearly and completely describes the technical solutions in this application with reference to the accompanying drawings. Clearly, the described implementations are some but not all of the implementations of this application. All other implementations obtained by a person of ordinary skill in the art based on the implementations of this application without creative efforts shall fall within the protection scope of this application. In addition, technical features included in different implementations of this application described below can be combined with each other provided that they do not conflict with each other.

Some terms used in embodiments of this application are first described to facilitate understanding of a person skilled in the art.

A terminal device can be a mobile terminal, a fixed terminal, or a portable terminal, for example, a mobile phone, a station, a unit, a device, a multimedia computer, a multimedia tablet, an Internet node, a communicator, a desktop computer, a laptop computer, a notebook computer, a netbook computer, a tablet computer, a personal communication system device, a personal navigation device, a personal digital assistant, an audio/video player, a digital camera/camera, a positioning device, a television receiver, a radio broadcast receiver, an electronic book device, a game device, or any combination thereof, including accessories and peripherals of these devices or any combination thereof. It can be further predicted that the terminal device can support any type of user-specific interface (for example, a wearable device), etc. A terminal device can also be a virtual terminal implemented through various levels of virtual machines.

A server can be an independent physical server or a virtual server; or can be a server cluster or a distributed system including a plurality of physical servers or virtual servers; or can be a cloud server that provides a basic cloud computing service such as a cloud service, a cloud database, cloud computing, a cloud function, cloud storage, a network service, cloud communication, a middleware service, a domain name service, a security service, big data, or an artificial intelligence platform.

The following describes the technical ideas of this application.

In the related technology, a plurality of clients and a plurality of data servers are usually respectively deployed in different VPCs, and VPC peering is established between each client and a corresponding data server. During data access, the client can access the corresponding data server through an established private connection, to implement security isolation between different data servers.

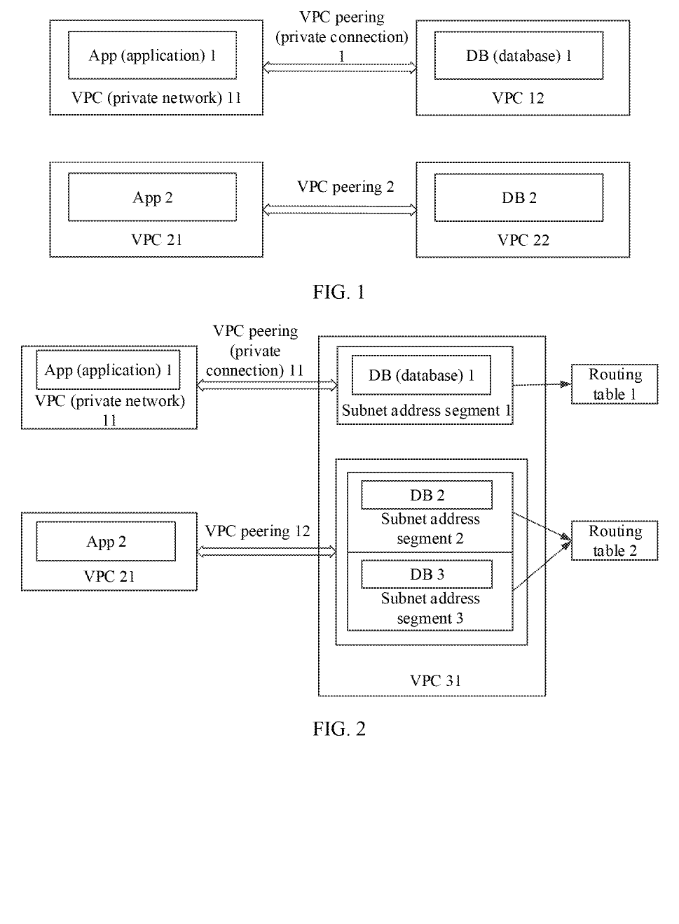

In an example, the data server can be a database server, and the client can be an application (APP). The following describes VPC-based data access with reference to FIG. 1. FIG. 1 is an example diagram of an architecture of a data access system in a related technology. A plurality of VPCs, e.g., a VPC 11, a VPC 12, a VPC 21, and a VPC 22 are included in FIG. 1. An app 1 and an app 2 are respectively deployed in the VPC 11 and the VPC 21 with respective user accounts. A database (DB) 1 and a DB 2 are deployed in the VPC 12 and the VPC 22 with cloud accounts. After VPC peering 1 between the app 1 and the DB 1 is established and VPC peering 2 between the app 2 and the DB 2 is established, the app 1 can access the DB 1 through VPC peering 1, and the app 2 can access the DB 2 through VPC peering 2.

However, as a quantity of users increases, a quantity of VPCs that need to be created also increases continuously. However, because of a resource limitation, a quantity of VPCs that can be created is usually limited. It is clearly difficult to satisfy a VPC requirement of the user.

It is considered that a local area network address segment corresponding to one VPC can be divided into a plurality of subnet address segments; a corresponding data server, a corresponding access control condition, and a corresponding routing table rule are configured for each subnet address segment; and different data access control is performed on data servers corresponding to all subnet address segments based on the access control condition and the routing table rule of each subnet address segment. Therefore, when data isolation between data servers of different users is considered, there is no need to create a large quantity of VPCs. Therefore, the implementations of this application provide a data access method and apparatus, an electronic device, and a storage medium, to ensure data isolation, and further reduce a quantity of consumed VPCs.

An embodiment of this application provides a data access system. The system includes a data processing system deployed in a first VPC and user equipment. The user equipment can be a terminal device or a server. The data processing system includes at least one data server, a client is disposed in the user equipment, and each client is deployed in a second VPC corresponding to each client. VPC peering is established between each client and a corresponding data server. Each client can access the corresponding data server based on VPC peering.

The following provides illustrative descriptions of an example data access system with reference to FIG. 2. FIG. 2 is an example diagram of an architecture of a data access system. In FIG. 2, an app 1 and an app 2 are respectively deployed in a VPC 11 and a VPC 21. Each DB is deployed in a VPC 31.

For example, a local area network address segment corresponding to the VPC 31 is divided into three subnet address segments, e.g., a subnet address segment 1, a subnet address segment 2, and a subnet address segment 3. A DB 1, a DB 2, and a DB 3 respectively correspond to the subnet address segment 1, the subnet address segment 2, and the subnet address segment 3. VPC peering 11 is established between the app 1 and the DB 1, and the same VPC peering 12 is established between the app 2 and each of the DB 2 and the DB 3. Each app can access a corresponding DB through corresponding VPC peering.

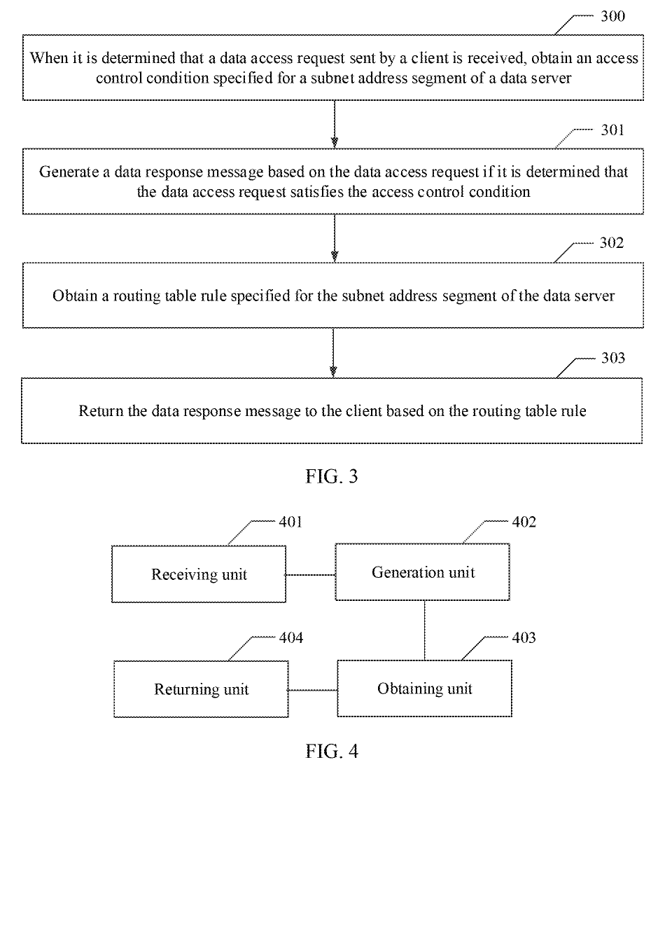

An implementation of this application provides a data access method. The method can be applied to any data server in a data processing system. The data server can be a single physical server or virtual server, or can be a cluster including a plurality of physical servers or virtual servers. FIG. 3 is a flowchart of a data access method according to an embodiment of this application. The following describes the method with reference to FIG. 3. An example implementation procedure of the method includes step 300 to step 303.

Step 300: When it is determined that a data access request sent by a client is received, obtain an access control condition configured for a subnet address segment of the data server.

The subnet address segment is obtained through division from a local area network address segment corresponding to a first VPC, and the client is deployed in a second VPC. Different clients are usually deployed in different second VPCs, and all data servers are deployed in the same VPC, e.g., the first VPC. The data access request includes source address information and destination address information. The source address information is a client address of the client, for example, a client IP address, and the destination address information is a server address of a to-be-accessed data server, for example, a server IP address.

In an implementation, an implementation process of step 300 can further include S3001 and S3002.

S3001: Obtain the local area network address segment correspondingly configured for the first VPC.

When a VPC is created, a local area network address segment is allocated to the VPC.

S3002: Divide the local area network address segment, to obtain a plurality of subnet address segments.

In an implementation, the local area network address segment can be divided based on a network type of the local area network address segment and a quantity of data servers, to obtain the plurality of subnet address segments.

The network type can include a type A network, a type B network, and a type C network.

In an example, the network type is the type A network, and an address range is from 10.0.0.0 to 10.255.255.255. If the local area network address segment is 10.0.0.0/8, and the quantity of data servers is less than 16, there can be 220=1048576 subnet address segments. One of the subnet address segments can be 10.0.0.0/24.

"/8" indicates that the first 8 bits in the local area network address segment represent a network part and the remaining bits represent a host part.

In another example, the network type is the type B network, and an address range is from 172.16.0.0 to 172.31.255.255. If the local area network address segment is 172.16.0.0/16, and the quantity of data servers is less than 15, there can be 212=4096 subnet address segments. A quantity of subnet address segments that can be obtained through division for the type B network is far less than a quantity of subnet address segments that can be obtained through division for the type A network.

S3003: Allocate a corresponding subnet address segment to each data server.

One subnet address segment can correspond to one or more data servers.

S3004: Set a corresponding access control condition and a corresponding routing table rule for each subnet address segment.

In an implementation, an access control list (ACL) and a routing table are set for each subnet address segment.

The ACL includes an access control condition, and the routing table includes a routing table rule. The access control condition is used to filter a received packet (e.g., a data access request), and the routing table rule is used to filter a response packet (e.g., a data response message).

The subnet address segment and the routing table can be in a one-to-one correspondence, or can be a many-to-one correspondence. This is not limited here.

In FIG. 2, a subnet address segment 1 is correspondingly provided with a routing table 1, and a subnet address segment 2 and a subnet address segment 3 are correspondingly provided with a routing table 2.

In this way, the access control condition and the routing table rule corresponding to each subnet address segment can be configured, and subsequently, during data access, an access traffic limitation can be performed on a data server corresponding to each subnet address segment, to implement data isolation between different data servers.

Step 301: Generate a data response message based on the data access request if it is determined that the data access request satisfies the access control condition.

In an implementation, when step 301 is performed, steps S3011 and S3012 can be performed.

S3011: Obtain a client address in the data access request.

For example, the source address information, e.g., the client address, in the data access request is obtained.

S3012: If it is determined that the client address satisfies the access control condition, perform a data query based on the data access request, to obtain a query result.

In an implementation, the access control condition is that the source address information in the data access request is located in an access permission address segment.

In actual applications, both the access permission address segment and the access control condition can be set based on an actual application scenario. This is not limited here.

S3013: Generate the data response message based on the query result and the client address.

Further, the data access request is discarded if it is determined that the client address does not satisfy the access control condition.

In this way, a data flow-in limitation can be performed on the data server based on the access control condition, and only access of a client in a permitted IP segment is allowed, to improve data security.

Step 302: Obtain a routing table rule configured for the subnet address segment of the data server.

Step 303: Return the data response message to the client based on the routing table rule.

In an implementation, when step 303 is performed, steps S3031 and S3032 can be performed.

S3031: Determine a routing address segment corresponding to the client address based on the routing table rule.

The routing table rule includes routing address segments configured for different destination address information in a packet, to forward a corresponding packet based on the routing address segment.

S3032: Send the data response message to the client based on the routing address segment.

Further, the data response message is discarded if it is determined, based on the routing table rule, that a routing address segment corresponding to the client address does not exist.

In this way, a data response message is allowed to be transmitted from corresponding VPC peering based on a routing policy in the routing table.

In a related manner, to achieve data isolation between data servers corresponding to different users, all data servers need to be respectively deployed in different VPCs. However, when there is a relatively large quantity of data servers, a large quantity of VPCs are consumed. Because VPC resources are limited, a quota upper limit of a single cloud account is easily reached, and it is difficult to satisfy a requirement of a user.

Therefore, in this embodiment of this application, a larger local area network address segment allocated to a VPC is divided into a plurality of smaller subnet address segments; a corresponding access control condition and a corresponding routing table rule are configured for each subnet address segment; and packet filtering is performed on data sources and data responses of data servers respectively corresponding to all subnet address segments based on the access control condition and the routing table rule that are configured for each subnet address segment, so that data servers respectively corresponding to different subnet address segments serve different clients, and similar inter-VPC access traffic isolation is implemented between data servers in different subnet address segments, to reduce a quantity of consumed VPCs, and improve data security.

User information (including but not limited to user equipment information, personal user information, etc.) and data (including but not limited to data used for analysis, stored data, displayed data, etc.) in this application are information and data that are authorized by a user or that are fully authorized by each party. Furthermore, related data needs to be collected, used, and processed in compliance with relevant laws, regulations and standards of relevant countries and regions, and corresponding operation entries are provided for the user to choose to authorize or reject.

Based on the same inventive concept, an implementation of this application further provides a data access apparatus. A principle of resolving a problem by the above-mentioned apparatus and the above-mentioned device is similar to that of a data access method. Therefore, for an implementation of the apparatus, references can be made to an implementation of the method. Details are omitted for simplicity. The apparatus can be applied to an electronic device. This application sets no limitation on a type of the electronic device. The apparatus can be any device type suitable for an implementation, for example, a smartphone or a tablet computer. Details are omitted for simplicity in this application.

FIG. 4 is a structural block diagram of a data access apparatus according to an embodiment of this application. In some implementations, the example data access apparatus in this application includes a receiving unit 401, a generation unit 402, an obtaining unit 403, and a returning unit 404.

The receiving unit 401 is configured to: when it is determined that a data access request sent by a client is received, obtain an access control condition configured for a subnet address segment of a data server. The subnet address segment is obtained through division from a local area network address segment corresponding to the first VPC, and the client is deployed in a second VPC.

The generation unit 402 is configured to generate a data response message based on the data access request if it is determined that the data access request satisfies the access control condition.

The obtaining unit 403 is configured to obtain a routing table rule configured for the subnet address segment of the data server.

The returning unit 404 is configured to return the data response message to the client based on the routing table rule.

In an implementation, the receiving unit 401 is further configured to: obtain the local area network address segment correspondingly configured for the first VPC; divide the local area network address segment, to obtain a plurality of subnet address segments; allocate a corresponding subnet address segment to each data server; and set a corresponding access control condition and a corresponding routing table rule for each subnet address segment.

In an implementation, the generation unit 402 is configured to: obtain a client address in the data access request; if it is determined that the client address satisfies the access control condition, perform a data query based on the data access request, to obtain a query result; and generate the data response message based on the query result and the client address.

In an implementation, the generation unit 402 is further configured to discard the data access request if it is determined that the client address does not satisfy the access control condition.

In an implementation, the returning unit 404 is configured to: determine a routing address segment corresponding to the client address based on the routing table rule; and send the data response message to the client based on the routing address segment.

In an implementation, the returning unit 404 is further configured to discard the data response message if it is determined, based on the routing table rule, that a routing address segment corresponding to the client address does not exist.

In the data access method and apparatus, the electronic device, and the storage medium that are provided in the embodiments of this application, when it is determined that a data access request sent by a client is received, an access control condition configured for a subnet address segment of a data server is obtained. The subnet address segment is obtained through division from a local area network address segment corresponding to the first VPC, and the client is deployed in a second VPC. A data response message is generated based on the data access request if it is determined that the data access request satisfies the access control condition. A routing table rule configured for the subnet address segment of the data server is obtained. The data response message is returned to the client based on the routing table rule. In this way, the local area network address segment corresponding to the first VPC is divided into a plurality of subnet address segments, and different access control conditions and routing table rules are respectively set for different subnet address segments, so that the data server can limit access traffic based on an access control condition and a routing table rule of a corresponding subnet address segment, and a VPC does not need to be applied for each data server. In this way, a quantity of consumed VPCs is reduced while data isolation is ensured.

An implementation of this application provides an electronic device, including: a processor; and a memory, storing computer instructions, where the computer instructions are used to enable the processor to perform the method in any one of the above-mentioned implementations.

An implementation of this application provides a storage medium, storing computer instructions. The computer instructions are used to enable a computer to perform the method in any one of the above-mentioned implementations.

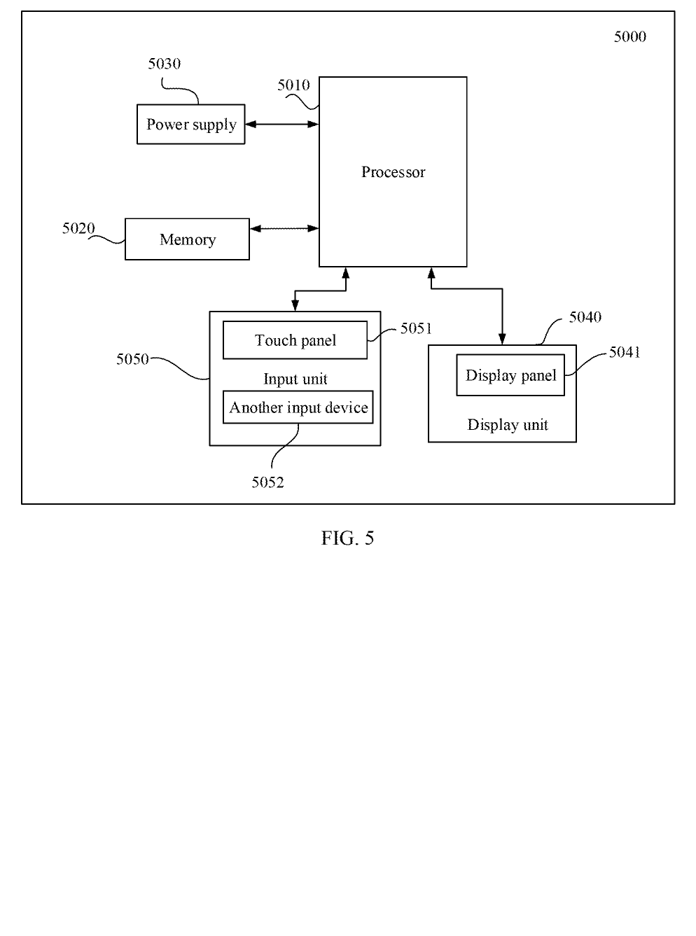

FIG. 5 is a schematic diagram of a structure of an electronic device 5000. As shown in FIG. 5, the electronic device 5000 includes a processor 5010 and a memory 5020. For example, the electronic device 5000 can further include a power supply 5030, a display unit 5040, and an input unit 5050.

In an example configuration, the device 5000 includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The processor 5010 is a control center of the electronic device 5000, is connected to various components through various interfaces and lines, and runs or executes a software program and/or data stored in the memory 5020, to perform various functions of the electronic device 5000.

In this embodiment of this application, when invoking a computer program stored in the memory 5020, the processor 5010 performs steps in the above-mentioned embodiments.

For example, the processor 5010 can include one or more processing units. Preferably, the processor 5010 can be integrated with an application processor and a modem processor. The application processor mainly processes an operating system, a user interface, an application, etc., and the modem processor mainly processes wireless communication. It can be understood that the modem processor does not need to be integrated into the processor 5010. In some embodiments, the processor and the memory can be implemented on a single chip. In some embodiments, the processor and the memory can be separately implemented on an independent chip.

The memory 5020 can mainly include a program storage area and a data storage area. The program storage area can store an operating system, various applications, etc. The data storage area can store data created based on use of the electronic device 5000, etc. In addition, the memory 5020 can include a high-speed random access memory, and can further include a nonvolatile memory, for example, at least one magnetic disk storage device, a flash memory device, or another volatile solid-state storage device.

The electronic device 5000 further includes a power supply 5030 (for example, a battery) that supplies power to each component. The power supply can be logically connected to the processor 5010 through a power management system, to implement functions such as management charging, discharging, and power consumption through the power management system.

The display unit 5040 can be configured to display information entered by a user or information provided for a user, various menus of the electronic device 5000, etc. In this embodiment of this application, the display unit 5040 is mainly configured to display a display interface of each application in the electronic device 5000 and objects such as a text and a picture that are displayed in the display interface. The display unit 5040 can include a display panel 5041. The display panel 5041 can be configured in a form of a liquid crystal display (LCD), an organic light-emitting diode (OLED), etc.

The input unit 5050 can be configured to receive information such as a digit or a character that is entered by the user. The input unit 5050 can include a touch panel 5051 and another input device 5052. The touch panel 5051 is also referred to as a touchscreen, and can collect a touch operation performed by the user on or near the touch panel 5051 (for example, an operation performed by the user on or near the touch panel 5051 by using any proper object or accessory, for example, a finger or a stylus).

For example, the touch panel 5051 can detect the touch operation performed by the user, detect a signal brought by the touch operation, convert these signals into contact coordinates, send the contact coordinates to the processor 5010, and receive and execute commands sent by the processor 5010. In addition, the touch panel 5051 can be implemented by using a plurality of types such as a resistive type, a capacitive type, an infrared type, and a surface acoustic wave type. The another input device 5052 can include but is not limited to one or more of a physical keyboard, a function key (for example, a volume control key or an on/off key), a trackball, a mouse, or an operating rod.

Certainly, the touch panel 5051 can cover the display panel 5041. After detecting a touch operation on or near the touch panel 5051, the touch panel 5051 sends the touch operation to the processor 5010 to determine a type of a touch event. Then the processor 5010 provides a corresponding visual output on the display panel 5041 based on the type of the touch event. In FIG. 5, the touch panel 5051 and the display panel 5041 serve as two independent components, to implement input and output functions of the electronic device 5000. However, in some embodiments, the touch panel 5051 and the display panel 5041 can be integrated to implement the input and output functions of the electronic device 5000.

The electronic device 5000 can further include one or more sensors such as a pressure sensor, a gravity acceleration sensor, and an optical proximity sensor. Certainly, based on an application requirement, the electronic device 5000 can further include another component such as a camera. Because the component is not a component that is mainly used in this embodiment of this application, the component is not shown in FIG. 5 and is not described in detail.

A person skilled in the art can understand that FIG. 5 shows merely an example of the electronic device, and constitutes no limitation on the electronic device. The electronic device can include more or fewer components than those shown in the figure, or can combine some components, or have different components.

For convenience of description, the above-mentioned parts are divided into modules (or units) for description by function. Certainly, when this application is implemented, the functions of each module (unit) can be implemented in one or more pieces of software or hardware.

Clearly, the above-mentioned implementations are merely an example for clear description, but are not a limitation on the implementations. A person of ordinary skill in the art can make other changes or modifications in different forms on the basis of the above-mentioned descriptions. All implementations do not need to be and cannot be exhausted here. However, clear changes or modifications drawn from this still fall within the protection scope created in this application.

What is claimed is:

1. A data access method, comprising:
in response to a data access request from a client, obtaining an access control condition for a subnet address segment of a data server of a data processing system, the data processing system deployed in a first virtual private cloud (VPC), wherein the subnet address segment is a part of a local area network address segment corresponding to the first VPC, and the client is deployed in a second VPC;
generating a data response message based on the data access request in response to it is determined that the data access request satisfies the access control condition;
obtaining a routing table rule for the subnet address segment of the data server; and
sending the data response message to the client based on the routing table rule.

2. The method according to claim 1, further comprising:
before the obtaining the access control condition for the subnet address segment of the data server,
obtaining the local area network address segment configured for the first VPC;
dividing the local area network address segment, to obtain a plurality of subnet address segments;
allocating a corresponding subnet address segment to each data server on the first VPC; and
setting a corresponding access control condition and a corresponding routing table rule for each subnet address segment.

3. The method according to claim 1, wherein the generating the data response message based on the data access request in response to it is determined that the data access request satisfies the access control condition comprises:
obtaining a client address in the data access request;
in response to it is determined that the client address satisfies the access control condition, performing a data query based on the data access request, to obtain a query result; and
generating the data response message based on the query result and the client address.

4. The method according to claim 3, further comprising:
discarding the data access request in response to it is determined that the client address does not satisfy the access control condition.

5. The method according to claim 3, wherein the sending the data response message to the client based on the routing table rule comprises:
determining a routing address segment corresponding to the client address based on the routing table rule; and
sending the data response message to the client based on the routing address segment.

6. The method according to claim 5, further comprising:
discarding the data response message in response to it is determined, based on the routing table rule, that a routing address segment corresponding to the client address does not exist.

7. The method according to claim 1, wherein the subnet address segment is obtained through division from the local area network address segment corresponding to the first VPC.

8. An electronic device, comprising:
one or more processors; and
one or more memory devices, individually or collectively, storing computer instructions, the computer instructions, when executed by the one or more processors, enabling the one or more processors to, individually or collectively, implement actions including:
in response to a data access request from a client, obtaining an access control condition for a subnet address segment of a data server of a data processing system, the data processing system deployed in a first virtual private cloud (VPC), wherein the subnet address segment is a part of a local area network address segment corresponding to the first VPC, and the client is deployed in a second VPC;
generating a data response message based on the data access request in response to it is determined that the data access request satisfies the access control condition;
obtaining a routing table rule for the subnet address segment of the data server; and
sending the data response message to the client based on the routing table rule.

9. The electronic device according to claim 8, wherein the actions further include:
before the obtaining the access control condition for the subnet address segment of the data server,
obtaining the local area network address segment configured for the first VPC;
dividing the local area network address segment, to obtain a plurality of subnet address segments;
allocating a corresponding subnet address segment to each data server on the first VPC; and
setting a corresponding access control condition and a corresponding routing table rule for each subnet address segment.

10. The electronic device according to claim 8, wherein the generating the data response message based on the data access request in response to it is determined that the data access request satisfies the access control condition comprises:
obtaining a client address in the data access request;
in response to it is determined that the client address satisfies the access control condition, performing a data query based on the data access request, to obtain a query result; and
generating the data response message based on the query result and the client address.

11. The electronic device according to claim 10, wherein the actions further include:
discarding the data access request in response to it is determined that the client address does not satisfy the access control condition.

12. The electronic device according to claim 10, wherein the sending the data response message to the client based on the routing table rule comprises:
determining a routing address segment corresponding to the client address based on the routing table rule; and
sending the data response message to the client based on the routing address segment.

13. The electronic device according to claim 12, wherein the actions further include:
discarding the data response message in response to it is determined, based on the routing table rule, that a routing address segment corresponding to the client address does not exist.

14. The electronic device according to claim 8, wherein the subnet address segment is obtained through division from the local area network address segment corresponding to the first VPC.

15. A storage medium, storing computer instructions, the computer instructions, when executed by one or more processors, enabling the one or more processors to, individually or collectively, implement actions comprising:
in response to a data access request from a client, obtaining an access control condition for a subnet address segment of a data server of a data processing system, the data processing system deployed in a first virtual private cloud (VPC), wherein the subnet address segment is a part of a local area network address segment corresponding to the first VPC, and the client is deployed in a second VPC;
generating a data response message based on the data access request in response to it is determined that the data access request satisfies the access control condition;
obtaining a routing table rule for the subnet address segment of the data server; and
sending the data response message to the client based on the routing table rule.

16. The storage medium according to claim 15, wherein the actions further include:
before the obtaining the access control condition for the subnet address segment of the data server,
obtaining the local area network address segment configured for the first VPC;
dividing the local area network address segment, to obtain a plurality of subnet address segments;
allocating a corresponding subnet address segment to each data server on the first VPC; and
setting a corresponding access control condition and a corresponding routing table rule for each subnet address segment.

17. The storage medium according to claim 15, wherein the generating the data response message based on the data access request in response to it is determined that the data access request satisfies the access control condition comprises:
obtaining a client address in the data access request;
in response to it is determined that the client address satisfies the access control condition, performing a data query based on the data access request, to obtain a query result; and
generating the data response message based on the query result and the client address.

18. The storage medium according to claim 17, wherein the actions further include:
discarding the data access request in response to it is determined that the client address does not satisfy the access control condition.

19. The storage medium according to claim 17, wherein the sending the data response message to the client based on the routing table rule comprises:
determining a routing address segment corresponding to the client address based on the routing table rule; and
sending the data response message to the client based on the routing address segment.

20. The storage medium according to claim 19, wherein the actions further include:
discarding the data response message in response to it is determined, based on the routing table rule, that a routing address segment corresponding to the client address does not exist.
